(19) United States
(12) Patent Application Publication
(10) Pub. No.: US 2017/0119620 A1
(43) Pub. Date: May 4, 2017

(54) VIBRATORY MASSAGE DEVICE

(71) Applicant: Sandra Trapp, Decatur, GA (US)

(72) Inventor: Sandra Trapp, Decatur, GA (US)

(21) Appl. No.: 15/339,351

(22) Filed: Oct. 31, 2016

Related U.S. Application Data
(63) Continuation-in-part of application No. 29/573,327, filed on Aug. 4, 2016.
(60) Provisional application No. 62/249,383, filed on Nov. 2, 2015.

(51) Int. Cl. A61H 23/02; A61H 23/00

(52) U.S. Cl. CPC A61H 23/02; A61H 23/00; A61H 2205/02; A61H 2205/06; A61H 2205/10; A61H 2205/08; A61H 2205/062

(57) ABSTRACT

Implementations of a vibratory massage device used for the treatment and/or relief of pain are provided. In some implementations, the vibratory massage device may comprise a flexible band having three vibration motors enclosed within individual housings and two power sources secured thereon, a switch for selectively energizing the vibration motors, and a removable sleeve. In some implementations, the flexible band may be configured to wrap around a portion of a human body (e.g., an arm, leg, torso, head, and/or shoulder) and be secured in place through the use of a provided strap. When the vibratory massage device is positioned on the portion of the body where the user is experiencing pain, the vibration generated by each vibration motor may disrupt the transmission of pain signals to the brain. In this way, the vibratory massage device may be used to treat and/or relieve pain.

### CROSS REFERENCE TO RELATED APPLICATION

This application claims the benefit of U.S. Patent Application Ser. No. 62/249,383, which was filed on Nov. 2, 2015, and U.S. Design patent application Ser. No. 29/573,327, which was filed on Aug. 4, 2016, both of which are incorporated herein by reference in their entirety.

### TECHNICAL FIELD

This disclosure relates to implementations of a vibratory massage device.

### BACKGROUND

Chronic pain is often managed using an interdisciplinary approach that may rely on pharmacological measures, interventional procedures, and/or physical therapy. Each of these approaches has its own limitations and drawbacks. While many pharmacological compositions are effective for the management of pain, some chronic pain may not be effectively managed by medication. Further, narcotic pharmaceuticals have a high abuse potential and can impair patient function.

Cutaneous vibration can effectively reduce pain, an effect called vibratory analgesia. Studies have shown that high frequency vibration (e.g., 100 Hz) can help reduce some types of pain, including pain associated with arthritis and fibromyalgia by more than 40 percent. Cutaneous vibration provides greater pain relief when it is applied to the area of the body where the sufferer is experiencing pain and is effective for treating local and/or regional pain. Some studies suggest that vibratory analgesia might work by interfering with the transmission of pain signals from various parts of the body to the central nervous system.

The present invention provides a device that may be secured about a portion of a patient's body and produce high frequency vibration to treat and/or relieve chronic pain without the use of pharmacological compositions.

### SUMMARY OF THE INVENTION

The present invention provides a vibratory massage device used to treat and/or relieve pain. In some implementations, the vibratory massage device may be used to treat and/or relieve the symptoms of pain associated with phantom pain, arthritis, fibromyalgia, and/or infantile colic.

In some implementations, the vibratory massage device may comprise a flexible band having three vibration motors enclosed within individual housings and two power sources secured thereon, a switch for selectively energizing the vibration motors, and a removable sleeve. In some implementations, the removable sleeve may be configured to envelope the vibration motors and their housings, the power sources, and a portion of the flexible band. In this way, the vibration motor housings and the power sources may be protected from the outside environment.

In some implementations, the flexible band may be configured to wrap around a portion of a human body (e.g., an arm, leg, torso, head, and/or shoulder). In some implementations, a strap may be used to secure a first end and a second end of the flexible band together. In this way, the vibratory massage device may be secured about a portion of a user's body.

In some implementations, each housing may comprise a base member having a capsule cover removably secured thereto. In some implementations, each housing is configured to enclose a vibration motor therein. In this way, the rotating shaft and eccentric rotating mass of each vibration motor is protected from the outside environment.

In some implementations, the base member of each housing is configured (e.g., manufactured from a rigid material) so that the centrifugal force generated by each vibration motor can rapidly displace the base member it is resting on and thereby generate the desired vibration.

In some implementations, a bottom portion of each base member may reside within an opening that extends through the flexible band of the vibratory massage device. In this way, the vibration generated by each vibration motor and base member combination can travel through the flexible band and be felt on the portion of the user's body that each base member is in contact with.

In some implementations, each power source may comprise a housing conductively connected to the vibration motors and the switch. In some implementations, each housing may be configured to contain one or more batteries therein. Through the use of batteries, the vibratory massage device is portable.

In some implementations, the mounting structure on the flexible band to which each power source is secured may be configured to contour the removable sleeve about the power source housings and the vibration motor housings.

In some implementations, each vibration motor and its associated housing are evenly spaced apart on the flexible band so as to evenly distribute the vibration forces generated thereby over as large an area as possible.

In some implementations, each vibration motor housing may be individually mounted to the flexible band of the vibratory massage device. In this way, the band remains flexible and is not prevented from contouring to the body of a user during use. In some implementations, each power source may be individually mounted to the flexible band of the vibratory massage device. In this way, the band remains flexible and is not prevented from contouring to the body of a user during use.

In some implementations, each vibration motor may have an inline rotating shaft with an eccentric rotating mass thereon. In some implementations, each vibration motor may have an operational vibration frequency of approximately 100 Hz. In some implementations, each vibration motor may have an operational vibration frequency ranging between 50 Hz-180 Hz, inclusive of 50 Hz and 180 Hz.

When the vibratory massage device is positioned on the portion of the body (e.g., an arm, leg, torso, head, and/or shoulder) where the user is experiencing pain, the vibration generated by each vibration motor may disrupt the transmission of pain signals to the brain. In this way, the vibratory massage device may be used to treat and/or relieve pain and/or other symptoms associated with phantom pain, arthritis, fibromyalgia, and/or infantile colic.

In some implementations, the bottom side of the sleeve may include openings that extend therethrough that are in alignment with the openings that extend through the flexible band. In this way, the sleeve does not disrupt the vibration generated by each vibration motor and base member combination from traveling to the portion of the body where the user is experiencing pain.

In some implementations, when the sleeve is positioned on the vibratory massage device, the switch may be felt through the sleeve and toggled between an “ON” and “OFF” position.

### BRIEF DESCRIPTION OF THE DRAWINGS

FIG. 1 illustrates an exploded isometric top view of a vibratory massage device according to the principles of the present disclosure.

FIG. 2A illustrates an isometric top view of the vibratory massage device shown in FIG. 1, with the removable sleeve positioned thereon.

FIG. 2B illustrates an isometric bottom view of the vibratory massage device shown in FIG. 1.

FIG. 2C illustrates a right side view of the vibratory massage device shown in FIG. 1.

FIG. 2D illustrates a left side view of the vibratory massage device shown in FIG. 1.

FIG. 3A illustrates an isometric top view of the vibratory massage device shown in FIG. 1, without the removable sleeve positioned thereon.

FIG. 3B illustrates an isometric bottom view of the vibratory massage device shown in FIG. 3A.

FIG. 3C illustrates a right side view of the vibratory massage device shown in FIG. 3A.

FIG. 3D illustrates a left side view of the vibratory massage device shown in FIG. 3A.

FIG. 4 illustrates a top view of the vibratory massage device shown in FIG. 3A. The capsule cover of each housing has been removed and the wiring connecting the switch, vibration motors, and power sources is shown.

FIG. 5 illustrates an example schematic view of the electronic circuit of the vibratory massage device according to the principles of the present disclosure.

FIGS. 6A and 6B illustrate a strap constructed according to the principles of the present disclosure.

FIG. 7 illustrates a perspective view of the vibratory massage device shown in FIG. 2A, having a strap secured to the second end thereof. The sleeve is partially cutaway to revel the position of the switch.

FIG. 8A illustrates a perspective view of a power source housing according to the principles of the present disclosure.

FIG. 8B illustrates a side view of the power source housing shown in FIG. 8A.

FIG. 8C illustrates a top view of the power source housing shown in FIG. 8A.

FIG. 9A illustrates a perspective view of a housing base member according to the principles of the present disclosure.

FIG. 9B illustrates a side view of the housing base member shown in FIG. 9A.

FIG. 10A illustrates a perspective view of a flexible band according to the principles of the present disclosure.

FIG. 10B illustrates a top view of the flexible band shown in FIG. 10A.

### DETAILED DESCRIPTION

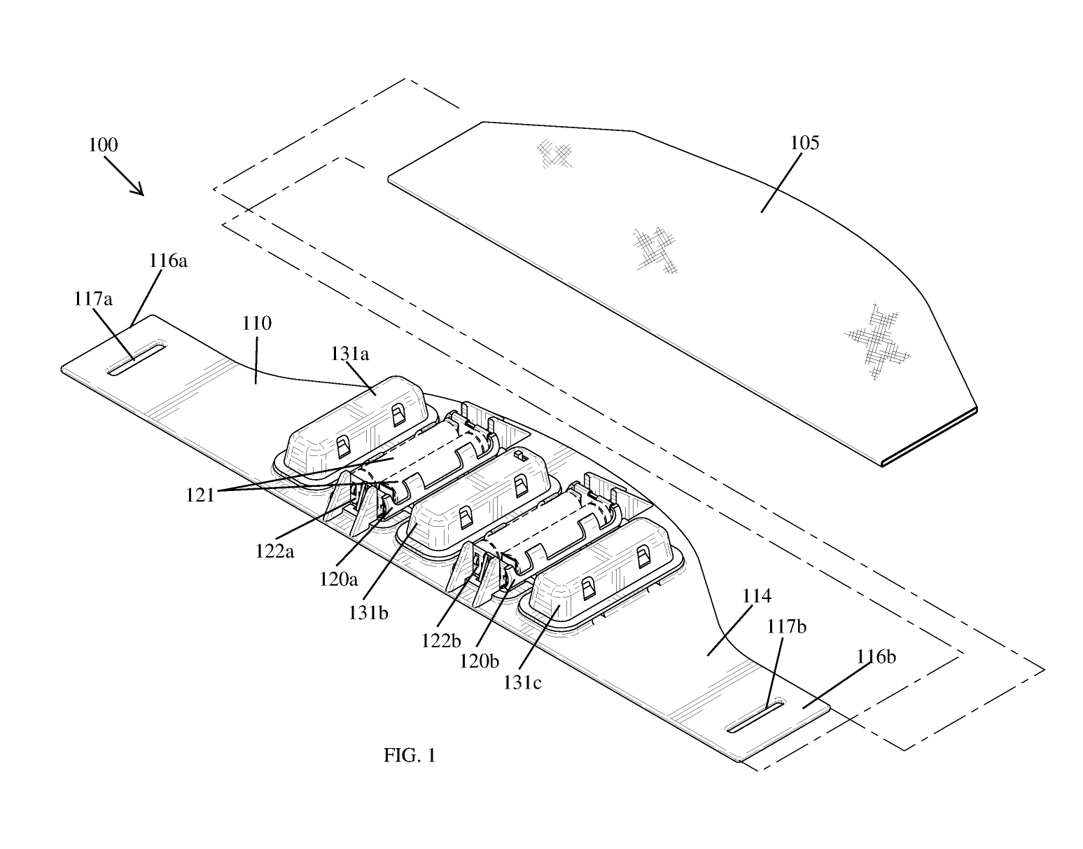

FIG. 1 illustrates an example vibratory massage device 100 according to the principles of the present disclosure. In some implementations, the vibratory massage device 100 may be used to treat and/or relieve pain. In some implementations, the vibratory massage device 100 may be used to treat and/or relieve the symptoms of pain associated with phantom pain, arthritis, fibromyalgia, and/or infantile colic. In some implementations, the vibratory massage device may be wearable and/or portable.

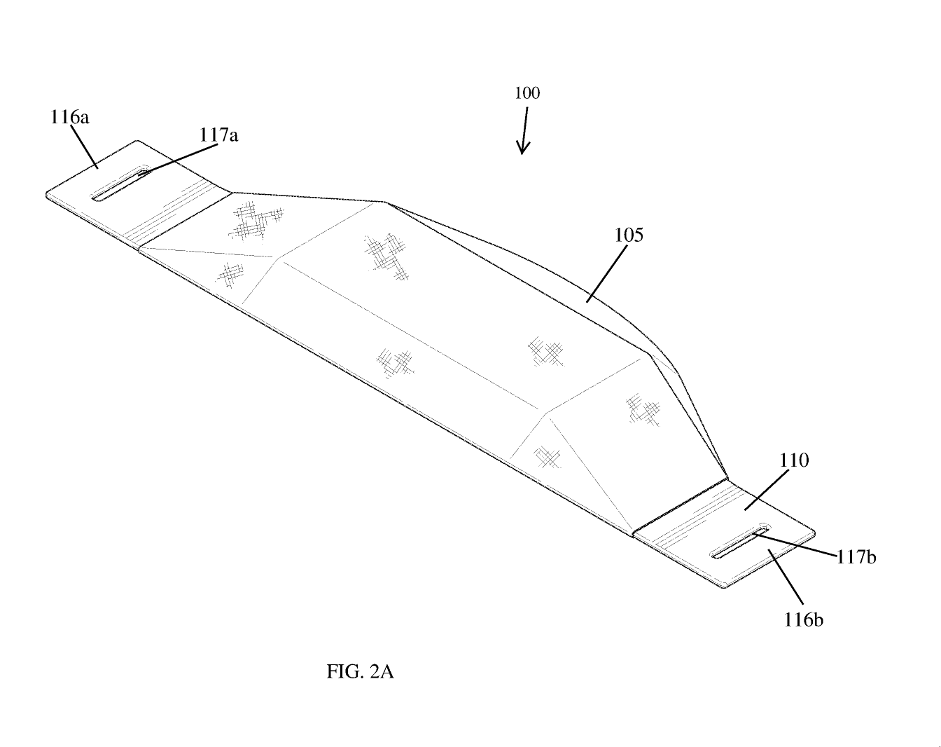

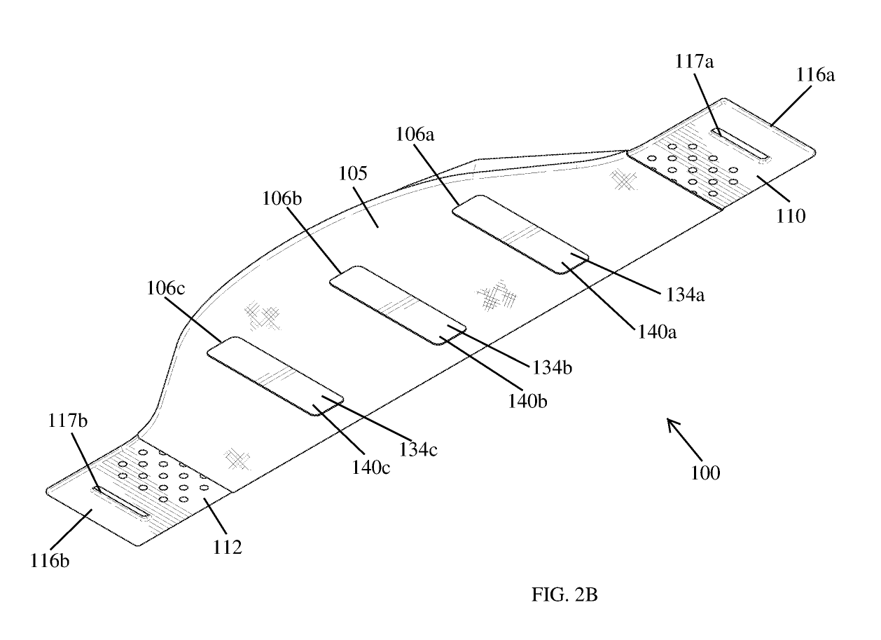

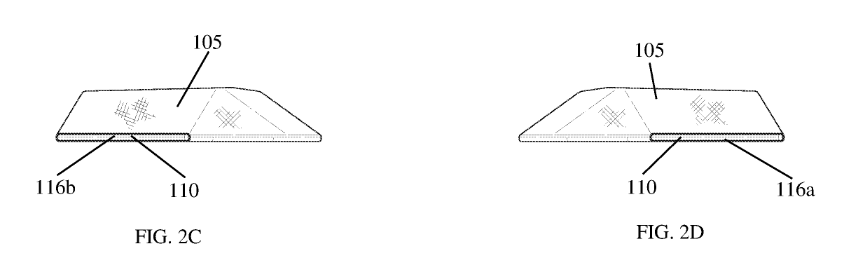

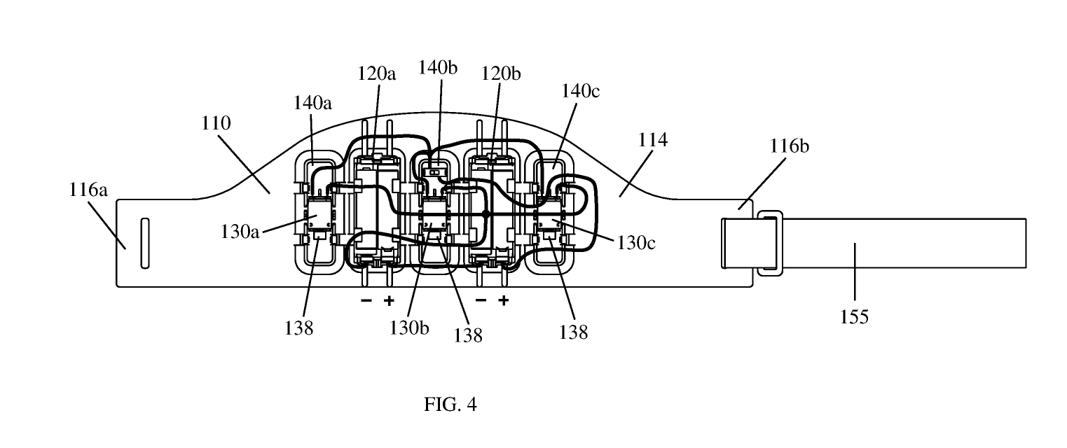

As shown in FIGS. 1 and 4, in some implementations, the vibratory massage device 100 may comprise a flexible band 110 having three vibration motors 130 (i.e., vibration motors 130a, 130b, 130c) enclosed within individual housings 131 (i.e., housings 131a, 131b, 131c) and two power sources (i.e., power sources 120a, 120b) secured thereon, a switch 150 for selectively energizing the vibration motors 130, and a removable sleeve 105. In some implementations, the removable sleeve 105 may be configured to envelope the vibration motors 130 and their housings 131, the power sources 120, and a portion of the flexible band 110 (see, e.g., FIG. 2A).

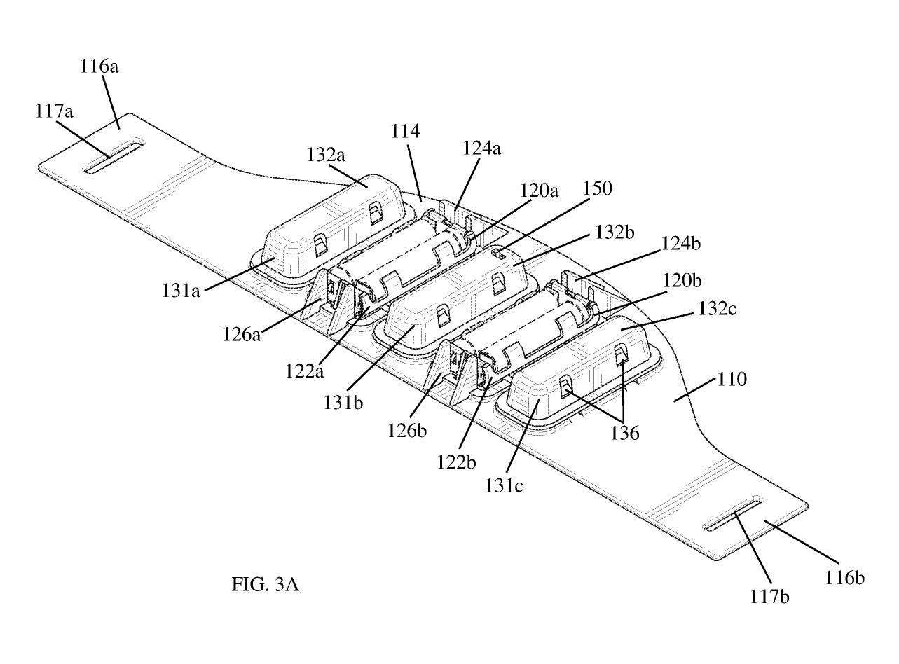

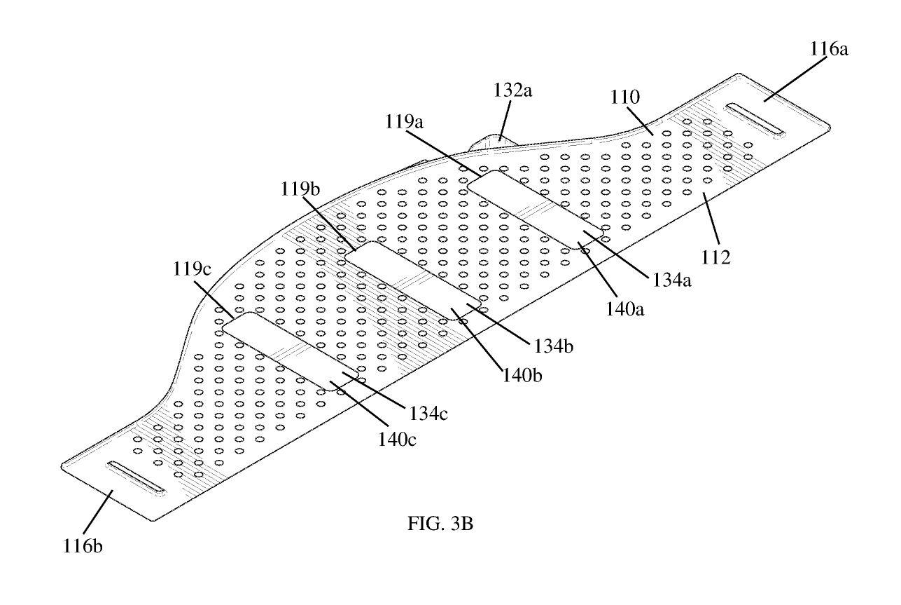

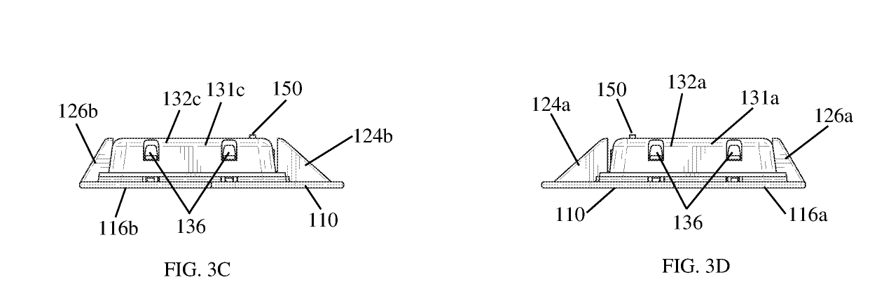

As shown in FIGS. 3A and 3B, in some implementations, the flexible band 110 includes a first side 112 that is oriented towards the user's body when secured thereabout and a second side 114 that is opposite the first side 112. In some implementations, the flexible band 110 may be configured to wrap around a portion (e.g., an arm, leg, torso, head, and/or shoulder) of a human body. In some implementations, the flexible band 110 may be elastic. In some implementations, the length of the flexible band 110 may be adjustable. In some implementations, the length of the flexible band 110 may not be adjustable. In some implementations, the flexible band 110 may be constructed in any shape and/or size suitable for being wrapped around a portion (e.g., an arm, leg, torso, head, and/or shoulder) of a human body that is otherwise suitable for use as part of a vibratory massage device 100.

As shown in FIGS. 3A and 3B, in some implementations, the flexible band 110 may have a first end 116a and a second end 116b. In some implementations, the first end 116a and the second end 116b of the flexible band 110 may have a first opening 117a (or slot) and a second opening 117b (or slot), respectively, therethrough.

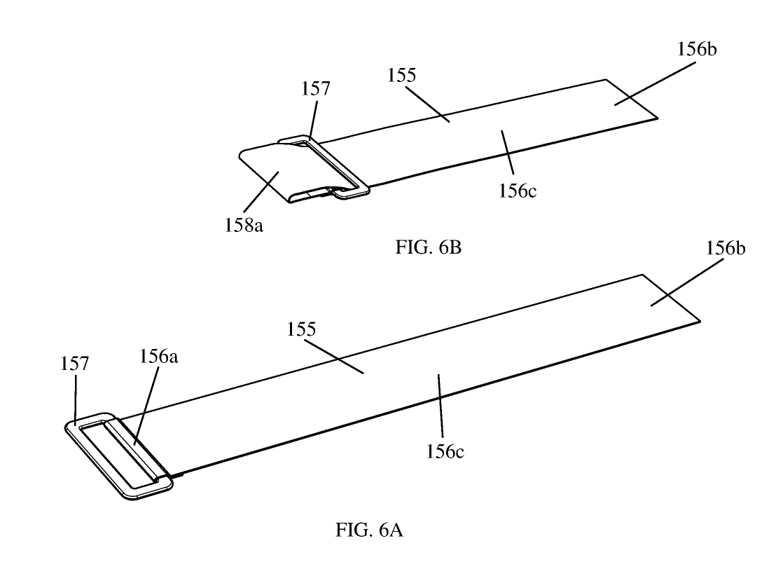

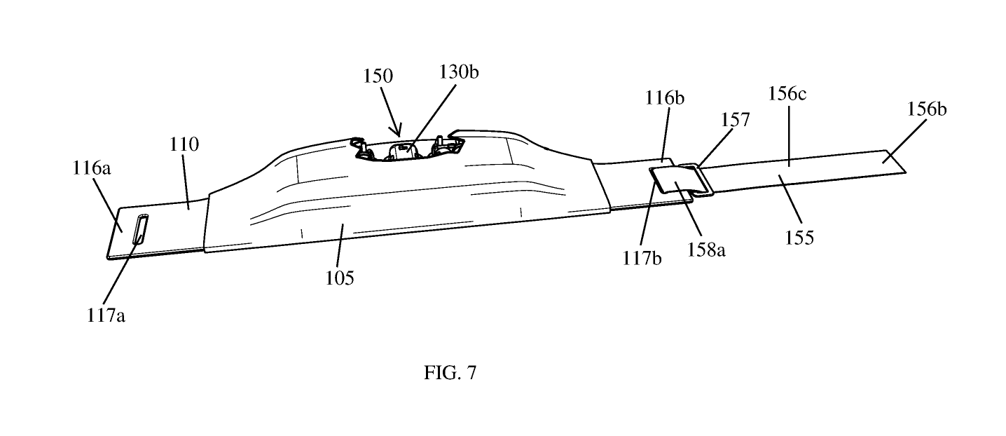

As shown in FIGS. 6A, 6B, and 7, in some implementations, a strap 155 may be used to secure the first end 116a and the second end 116b of the flexible band 110 together. In this way, the flexible band 110 and thereby the vibratory massage device 100 as a whole may be secured about a portion of a user's body.

In some implementations, the strap 155 may comprise a first end 156a having a buckle 157 thereon, a second end 156b, and a middle section 156c extending therebetween (see, e.g., FIGS. 6A and 6B). In some implementations, the strap 155 may be configured to adjust the fit of the flexible band 110 about the portion of the body where the user is experiencing pain.

In some implementations, the following steps may be used to secure the first end 116a of the flexible band 110 to the second end 116b using a strap 155:

Initially, in some implementations, the second end 156b of the strap 155 may be inserted through the second opening 117b of the flexible band 110. Then, the second end 156b of the strap 155 is inserted through the opening of the buckle 157. In this way, a first loop 158a about the second end 116b of the flexible band 110 may be formed (see, e.g., FIG. 7).

Next, in some implementations, the second end 156b of the strap 155 may be inserted through the first opening 117a of the flexible band 110. Then, the second end 156b of the strap 155 is folded over and removably secured to the middle section 156c. In this way, a second loop about the first end 116a of the flexible band 110 may be formed.

In some implementations, the second end 156b of the strap 155 may be removably secured to the middle section 156c by hook and loop fasteners. In some implementations, a section of hook and loop fasteners may be positioned on the second end 156b and the middle section 156c of the strap 155. In this way, the two sections are mateable with each other when the second end 156b and the middle section 156c of the strap 155 are brought together.

In some implementations, the second end 156b and the middle section 156 of the strap 155 may be removably secured together to form a loop using fastening means such as buttons, and/or other reclosable fasteners, or any other attachment or fastening technology existing or developed in the future.

As shown in FIGS. 3A and 3B, each housing 131 (i.e., housing 131a, 131b, 131c) may comprise a base member 134 (i.e., base member 134a, 134b, 134c) having a capsule cover 132 (i.e., capsule cover 132a, 132b, 132c) removably secured thereto. In some implementations, each housing 131 is configured to enclose a vibration motor 130 therein. In this way, the rotating shaft and eccentric rotating mass 138 of each vibration motor 130 is protected from the outside environment. In some implementations, each housing 131 may protect a portion of the conductive wiring that connects each vibration motor 130 to a power source(s) 120 and/or the switch 150.

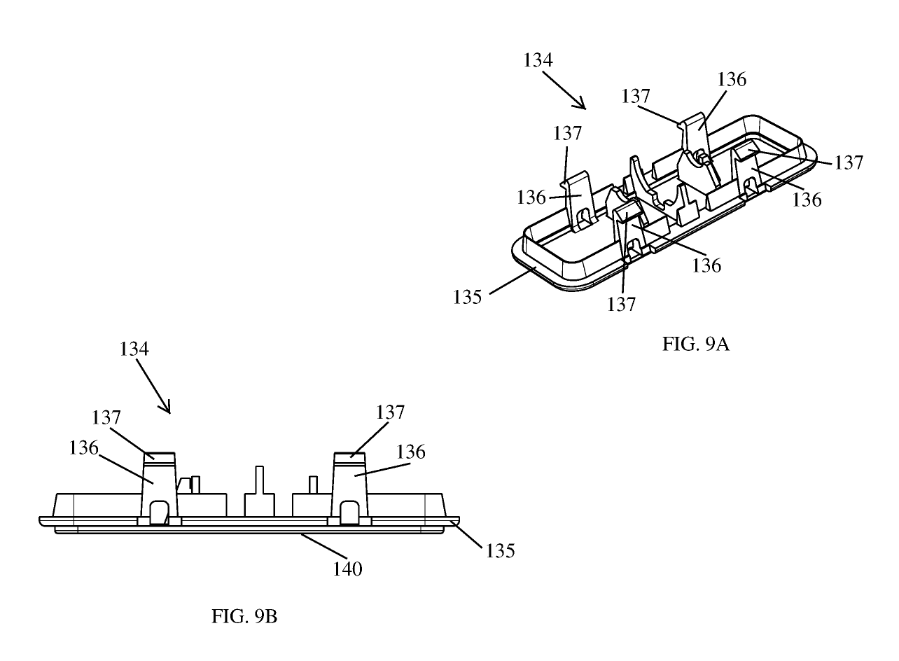

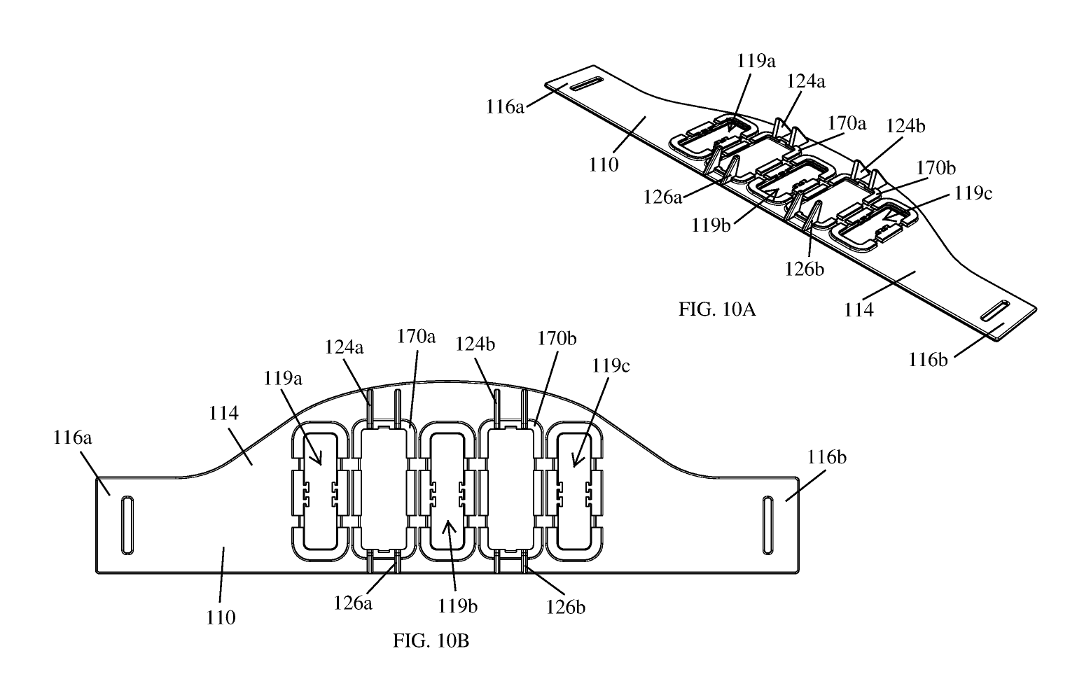

In some implementations, the base member 134 of each housing 131 is secured to the flexible band 110 of the vibratory massage device 100. In some implementations, the base member 134 of each housing (131a, 131b, 131c) may include a lip 135 thereon that is configured to interface with an annular recess located about the interior of each opening (119a, 119b, 119c) that extends through the flexible band 110 (see, e.g., FIGS. 9A and 10A). In this way, the base member 134 of each housing 131 may be secured to the flexible band 110. In some implementations, each base member 134 is configured to support a vibration motor 130 thereon. In some implementations, the base member 134 of each housing 131 is configured (e.g., manufactured from a rigid material) so that the centrifugal force generated by each vibration motor 130 will rapidly displace the base member 134 it is resting on and thereby generate the desired vibration.

As shown in FIG. 3B, in some implementations, a bottom portion 140 (i.e., bottom portion 140a, 140b, 140c) of each base member 134 may reside within an opening 119 (i.e., opening 119a, 119b, 119c) that extends through the flexible band 110 of the vibratory massage device 100. In this way, the vibration generated by each vibration motor 130 and base member 134 combination can travel through the flexible band 110 and be felt on the portion of the user's body that the bottom portion 140 is in contact with. In some implementations, the bottom portion 140 of each base member 134 is flush with the first side 112 of the flexible band 110. In some implementations, the bottom portion 140 of each base member 134 may extend past the first side 112 of the flexible band 110. In some implementations, the bottom portion 140 of each base member 134 that resides within an opening 119 of the flexible band 110 may be shaped like a rectangle (see, e.g., FIG. 3B). In some implementations, the bottom portion 140 of the base member 134 that resides within an opening 119 of the flexible band 110 may be any shape suitable for working in conjunction with a vibration motor 130 to generate a vibratory force. In some implementations, the bottom portion 140 of each base member 134 that resides within an opening 119 of the flexible band 110 may be referred to as a rigid transfer surface.

As shown in FIGS. 9A and 9B, in some implementations, each base member 134 may include four flexible members 136 extending upwardly therefrom that are configured to releasably secure a capsule cover 132 thereon. In some implementations, each flexible member 136 may include a lip 137 on its distal end thereby forming a ledge. In use, each lip 137 may overlap an edge of an opening in a capsule cover 132 and thereby assist in securing the capsule cover 132 to the base member 134 (see, e.g., FIGS. 3A, 3C, and 3D).

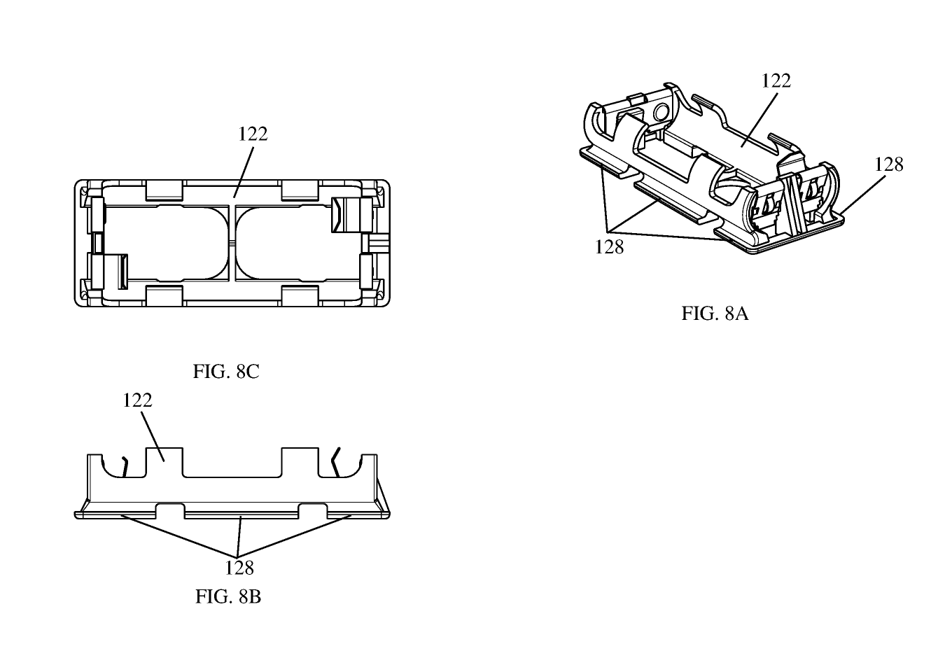

As shown in FIGS. 1, 3A, and 5, in some implementations, each power source 120 may comprise a housing 122 (i.e., housing 122a, 122b) conductively connected to the vibration motors 130 and the switch 150. In some implementations, each power source housing 122 may include battery terminals therein (see, e.g., FIG. 8A). In some implementations, each housing 122 may be configured to contain one or more batteries 121 (e.g., AAA batteries) therein (see, e.g., FIG. 1). Through the use of batteries 121, the vibratory massage device 100 is portable. Where batteries are used, alkaline batteries may be suitable. In some implementations, rechargeable lithium ion batteries may be used in place of alkaline batteries. In some implementations, any battery, or combination of batteries, suitable to cause the vibratory massage device 100 to operate within the desired vibration frequency range may be used.

In some implementations, the vibratory massage device 100 may use a conventional AC power line in lieu of batteries.

As shown in FIGS. 8A-8C, in some implementations, the base of each housing 122 may include a lip 128 thereon. In some implementations, the lip 128 may be configured to interface with a mounting structure 170 on the second side 114 of the flexible band 110 and thereby secure the housing 122 thereon (see, e.g., FIGS. 3A and 10B). In some implementations, each mounting structure (170a, 170b) on the flexible band 110 may include an annular recess configured to receive the lip 128 of a housing 122 therein and thereby secure the housing 122 of a power source 120 on the flexible band 110.

As shown in FIGS. 3A, 3C, and 3D, in some implementations, each mounting structure (170a, 170b) on the flexible band 110 may have a first end 124 (i.e., first end 124a, 124b) and a second end 126 (i.e., second end 126a, 126b). In some implementations, the first end 124 and the second end 126 of each mounting structure 170 may be configured to contour the removable sleeve 105 about the power source housings 122 and the vibration motor housings 131 (see, e.g., FIGS. 2C and 2D). In some implementations, the first end 124 of each mounting structure 170 may include two parallel wedges thereon having a first angle (see, e.g., FIGS. 3A, 3C, and 3D). In some implementations, the second end 126 of each mounting structure 170 may comprise two parallel wedges thereon having a second angle (see, e.g., FIGS. 3A, 3C, and 3D).

As shown in FIGS. 3A and 4, in some implementations, three vibration motor housings 131 and two power sources 120 may be positioned on the second side 114 of the flexible band 110. In some implementations, the vibration motor housings 131 are evenly spaced apart on the flexible band 110 to evenly distribute the vibration forces generated by the vibration motors 130 over as large an area as possible.

In some implementations, more than three or less than three vibration motors 130 may be used with a vibratory massage device 100. The number of housings 131 secured to the flexible band 110 corresponds to the number of vibration motors 130 being used with a particular implementation of the vibratory massage device 100.

In some implementations, more than two or less than two power sources 120 may be used with a vibratory massage device 100.

In some implementations, each housing 131 for a vibration motor 130 may be individually mounted to the flexible band 110 of the vibratory massage device 100 (see, e.g., FIGS. 1 and 4). In this way, the band 110 remains flexible and is not prevented from contouring to the body of a user during use.

In some implementations, each power source 120 may be individually mounted to the second side 114 of the flexible band 110 of the vibratory massage device 100 (see, e.g., FIGS. 1 and 4). In this way, the band 110 remains flexible and is not prevented from contouring to the body of a user during use.

In some implementations, each electrically powered vibration motor 130 may have an inline rotating shaft with an eccentric rotating mass 138 thereon (well known to those of ordinary skill in the art). In some implementations, each vibration motor 130 may have an operational vibration frequency of approximately 100 Hz. In some implementations, each vibration motor 130 may have an operational vibration frequency ranging between 50 Hz-180 Hz, inclusive of 50 Hz and 180 Hz. A vibration frequency of 50 Hz to 180 Hz may effectively block and/or disrupt pain signals from traveling to the brain, with 100 Hz or more being optimal.

When the vibratory massage device 100 is positioned on the portion (e.g., an arm, leg, torso, head, and/or shoulder) of the body where the user is experiencing pain, the vibration generated by each vibration motor 130 may disrupt the transmission of pain signals to the brain. In this way, for example, the vibratory massage device 100 may be used to treat and/or relieve pain and/or other symptoms associated with phantom pain, arthritis, fibromyalgia, and/or infantile colic.

As shown in FIGS. 1 and 2A-2D, in some implementations, an elastic sleeve 105 may be used to enclose the power sources 120 and the housings 131 for the vibration motors 130 that are secured to the flexible band 110 of the vibratory massage device 100. In this way, the vibration motor housings 131 and the power sources 120 may be protected from the outside environment. In some implementations, the sleeve 105 may be removable (see, e.g., FIG. 1). In this way, for example, the user may change the batteries, turn the vibratory massage device 100 on/off using the switch 150, clean the sleeve 105, and/or replace the sleeve 105. In some implementations, the sleeve 105 may be any shape suitable for enclosing the housing(s) 131 and power source(s) 120 of a vibratory massage device 100.

As shown in FIG. 2B, in some implementations, the bottom side of the sleeve 105 may include a first opening 106a, a second opening 106b, and a third opening 106c that extend therethrough. In some implementations, the first opening 106a, second opening 106b, and third opening 106c through the sleeve 105 are in alignment with the first opening 119a, second opening 119b, and third opening 119c, respectively, which extend through the flexible band 110. In this way, the sleeve 105 does not hinder or stop the vibration generated by each vibration motor 130 and base member 134 combination from traveling to the portion of the body where the user is experiencing pain.

In some implementations, the switch 150 may be felt through the sleeve 105 and toggled when the sleeve 105 is positioned on the vibratory massage device 100.

As shown in FIGS. 1 and 3A, in some implementations, the switch 150 may extend through an opening in the capsule cover 132b of the second housing 131b and be movable between a first position (e.g., an “ON” position) and a second position (e.g., an “OFF” position). In some implementations, the switch 150 may be used to selectively complete the electrical circuit 160 between the power sources 120 and the vibration motors 130. In this way, the switch 150 may be used to selectively energize the vibration motors 130 (i.e., turn the vibration motors 130 “ON” and “OFF”).

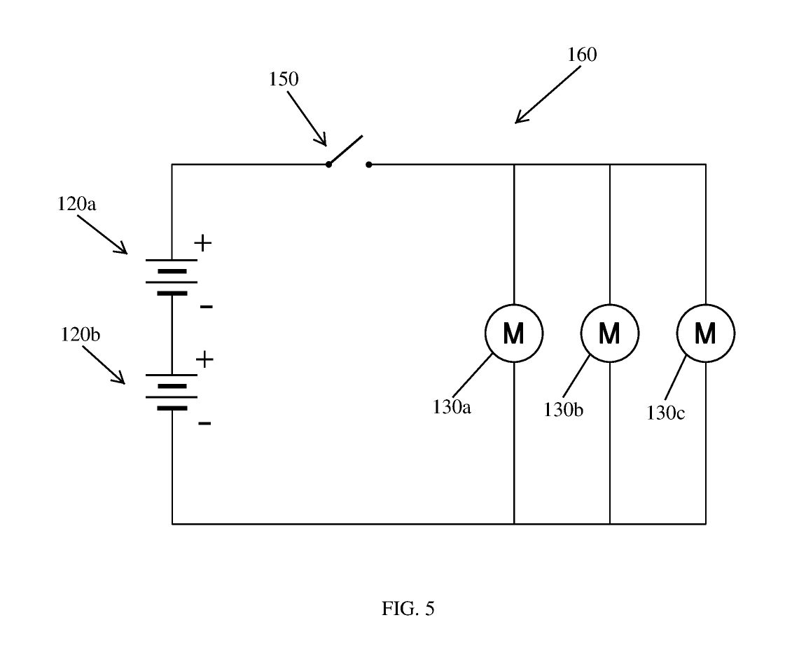

FIG. 5 shows an example implementation of an electronic circuit 160 used to control the operation of the vibratory massage device 100. In some implementations, the power switch 150 is conductively connected to the power sources 120 and the vibration motors 130. In some implementations, each vibration motor 130 may have one wire conductively connecting it to the power source(s) 120 and one wire conductively connecting it to the switch 150. One of ordinary skill in the art having the benefit of the present disclosure would know how to construct a suitable electronic circuit to operate the vibration motors 130 of a vibratory massage device 100.

Although not completely shown in the drawings, it will be understood that suitable wiring connects the electrical components (e.g., the power sources 120, vibration motors 130, and switch 150) of the vibratory massage device 100 disclosed herein.

To use the vibratory massage device 100 disclosed herein to treat and/or relieve pain, in some implementations, place the first side 112 of the flexible band 110 against the portion of the body where the user is experiencing pain. Then, in some implementations, position the flexible band 110 so that the rigid transfer surface (e.g., bottom portions 140a, 140b, 140c) of each housing 131 is positioned on or adjacent the portion of the body where the user is experiencing pain. Next, in some implementations, the first end 116a and the second end 116b of the flexible band 110 may be wrapped around opposite sides of the body adjacent the portion of the body where the user is experiencing pain. Then, in some implementations, the first end 116a and the second end 116b of the flexible band 110 are secured together using the strap 155 as disclosed above. In this way, the vibratory massage device 100 may be held in place on the selected portion of the user's body during use.

Next, in some implementations, the switch 150 may be used to energize the vibration motors 130.

In some implementations, the flexible band 110 and/or the sleeve 105 may be manufactured from rubberized nylon. In this way, the band 110 and/or the sleeve 105 may be water resistant and flexible. In some implementations, the flexible band 110 and/or the sleeve 105 may be manufactured from any material suitable for use as part of a vibratory massage device 100.

In some implementations, the flexible band 110 may be a single piece of material. In some implementations, the flexible band 110 may comprise multiple layers of material.

In some implementations, the power sources 120 and the housings 131 for the vibration motors 130 may be secured to the flexible band 110 using any method known to one of ordinary skill in the art that does not inhibit the band 110 from contouring to the body of a user or otherwise inhibit the proper function of the vibratory massage device 100.

Reference throughout this specification to “an embodiment” or “implementation” or words of similar import means that a particular described feature, structure, or characteristic is included in at least one embodiment of the present invention. Thus, the phrase “in some implementations” or a phrase of similar import in various places throughout this specification does not necessarily refer to the same embodiment.

Many modifications and other embodiments of the inventions set forth herein will come to mind to one skilled in the art to which these inventions pertain having the benefit of the teachings presented in the foregoing descriptions and the associated drawings.

The described features, structures, or characteristics may be combined in any suitable manner in one or more embodiments. In the above description, numerous specific details are provided for a thorough understanding of embodiments of the invention. One skilled in the relevant art will recognize, however, that embodiments of the invention can be practiced without one or more of the specific details, or with other methods, components, materials, etc. In other instances, well-known structures, materials, or operations may not be shown or described in detail.

While operations are depicted in the drawings in a particular order, this should not be understood as requiring that such operations be performed in the particular order shown, or in sequential order, or that all illustrated operations be performed, to achieve desirable results.

1. A vibratory massage device comprising:
a flexible band configured to wrap around a portion of a human body;
at least one power source, the at least one power source is secured to the flexible band;
at least one vibration motor;
at least one housing comprising a base member and a capsule cover, the at least one housing is configured to contain one vibration motor, the base member of the at least one housing is secured to the flexible band and the capsule cover is removably secured to the base member;
a switch configured to selectively energize the at least one vibration motor; and
a removable sleeve configured to envelope the at least one power source and the at least one housing;
wherein the switch is conductively connected to the at least one power source and the at least one vibration motor.

2. The vibratory massage device of claim 1, wherein there are two power sources and three housings secured to the flexible band, each housing contains one vibration motor.

3. The vibratory massage device of claim 2, wherein each power source comprises a housing configured to contain at least one battery.

4. The vibratory massage device of claim 2, wherein the base member of each housing is configured to support a vibration motor thereon, the base member of each housing is configured so that the centrifugal force generated by the vibration motor resting thereon will rapidly displace the base member and thereby generate a vibration.

5. The vibratory massage device of claim 4, wherein a bottom portion of each base member resides within an opening that extends through the flexible band.

6. The vibratory massage device of claim 2, wherein the two power sources and the three housings are individually secured to the flexible band.

7. The vibratory massage device of claim 2, wherein each vibration motor includes a rotating shaft with an eccentric rotating mass thereon.

8. The vibratory massage device of claim 7, wherein each vibration motor has an operational vibration frequency of at least 100 Hz.

9. The vibratory massage device of claim 7, wherein each vibration motor has an operational vibration frequency of between 50 Hz and 180 Hz, inclusive of 50 Hz and 180 Hz.

10. The vibratory massage device of claim 2, further comprising a strap configured to secure a first end and a second end of the flexible band together.

11. The vibratory massage device of claim 10, wherein the strap comprises a first end having a buckle thereon, a second end, and a middle section extending therebetween, the second end and the middle section of the strap are configured to be removably secured together.

12. A method of using a vibratory massage device, the method comprising:
providing a vibratory massage device comprising: a flexible band having a first end and a second end, the flexible band is configured to wrap around a portion of a human body; at least one power source, the at least one power source is secured to the flexible band; at least one vibration motor; at least one housing comprising a base member and a capsule cover, the at least one housing is configured to contain one vibration motor, the base member of the at least one housing is secured to the flexible band and the capsule cover is removably secured to the base member; a switch configured to selectively energize the at least one vibration motor; and a removable sleeve configured to envelope the at least one power source and the at least one housing; wherein the switch is conductively connected to the at least one power source and the at least one vibration motor;
placing the flexible band against a portion of a user's body where the user is experiencing pain;
wrapping the first end and the second end of the flexible band around opposite sides of the portion of the body where the user is experiencing pain; and
toggling the switch to energize the at least one vibration motor.

13. The method of claim 12, wherein the base member of the at least one housing is configured to support a vibration motor thereon, the base member of the at least one housing is configured so that the centrifugal force generated by the vibration motor resting thereon will rapidly displace the base member and thereby generate a vibration, a bottom portion of the base member resides within an opening that extends through the flexible band, the method further comprising:
positioning the flexible band so that the bottom portion of the base member residing within the opening that extends through the flexible band is positioned on or adjacent the portion of the body where the user is experiencing pain.

14. The method of claim 13, wherein the first end and the second end of the flexible band have a first opening and a second opening, respectively, therethrough; the vibratory massage device further comprises a strap configured to secure the first end and the second end of the flexible band together, the strap comprises a first end having a buckle thereon, a second end, and a middle section extending therebetween, the second end and the middle section of the strap are configured to be removably secured together, the method further comprises:
inserting the second end of the strap through the second opening of the flexible band; then
inserting the second end of the strap through an opening of the buckle, thereby forming a first loop about the second end of the flexible band; and
inserting the second end of the strap through the first opening of the flexible band; then
folding the second end of the strap over until it makes contact with the middle section, thereby forming a second loop about the first end of the flexible band.

15. The method of claim 13, wherein there are two power sources and three housings secured to the flexible band, each housing contains one vibration motor, the flexible band includes an opening therethrough for a bottom portion of each base member.

16. The method of claim 15, wherein the two power sources and the three housings are individually secured to the flexible band.

17. The method of claim 13, wherein each vibration motor includes a rotating shaft with an eccentric rotating mass thereon.

18. A vibratory massage device comprising:
a flexible band configured to wrap around a portion of a human body;
a first power source and a second power source, each power source is secured to the flexible band;
a first vibration motor, a second vibration motor, and a third vibration motor;
a first housing, a second housing, and a third housing, each housing is configured to contain one vibration motor and comprises a base member and a capsule cover, the base member of each housing is secured to the flexible band and the capsule cover is removably secured to the base member;
a switch configured to selectively energize the vibration motors; and
a removable sleeve configured to envelope the three housings and the two power sources;
wherein the switch is conductively connected to the two power sources and the three vibration motors.

19. The vibratory massage device of claim 18, wherein the base member of each housing is configured to support a vibration motor thereon, the base member of each housing is configured so that the centrifugal force generated by the vibration motor resting thereon will rapidly displace the base member and thereby generate a vibration.

20. The vibratory massage device of claim 19, wherein a bottom portion of the base member of the first housing resides within a first opening that extends through the flexible band, a bottom portion of the base member of the second housing resides within a second opening that extends through the flexible band, and a bottom portion of the base member of the third housing resides within a third opening that extends through the flexible band.
